(19) United States
(12) Patent Application Publication
(10) Pub. No.: US 2015/0015809 A1
(43) Pub. Date: Jan. 15, 2015

(54) TOUCH SCREEN PANEL AND METHOD FOR MANUFACTURING SAME

(71) Applicant: HON HAI PRECISION INDUSTRY CO., LTD., New Taipei (TW)

(72) Inventors: CHIN-YANG WU, New Taipei (TW); CHANG-CHIN WU, New Taipei (TW); TEN-HSING JAW, New Taipei (TW)

(21) Appl. No.: 14/325,941

(22) Filed: Jul. 8, 2014

(30) Foreign Application Priority Data
Jul. 15, 2013 (TW) 102125305

(51) Int. Cl. G06F 3/041

(52) U.S. Cl. CPC G06F 3/041
USPC 349/12; 216/15

(57) ABSTRACT

A touch screen panel includes a substrate, a plurality of first electrodes formed on the substrate and extending along a first axis direction, a plurality of second electrodes formed on the substrate and extending along a second axis substantially perpendicular to the first axis; and a plurality of conducting connectors. Each conducting connector electrically couples with two neighboring second electrodes among the plurality of second electrodes in a same row without contacting the first electrodes.

This application claims all benefits accruing under 35 U.S.C. §119 from TW Patent Application No. 102125305, filed on Jul. 15, 2013, in the Taiwan Intellectual Property Office, the disclosure of which is incorporated herein by reference.

### FIELD

The present disclosure generally relates to a touch screen panel and a method for manufacturing the touch screen panel.

### BACKGROUND

Touch screen panels are input devices that allow manual instruction to be input by touching the screen. A typical touch screen panel includes a substrate, a plurality of second electrodes and a plurality of first electrodes arranged among the plurality of second electrodes. The plurality of second electrodes and the plurality of first electrodes are made of a transparent electrode material, such as indium tin oxide (ITO) film. The first electrodes are electrically coupled to each other in a first axis direction. The second electrodes are dispersed between the first electrodes, and do not overlap with the first electrodes and can be formed to have separated patterns along a second axis direction that intersects the first direction. A conducting connector made of metal, such as silver or copper, is electrically coupled to each of two neighboring second electrodes in a same row. However, a reflectivity for a wavelength of a visible region of a metal is relatively high, which causes a poor readability in sunlight.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a plan view of one embodiment of touch screen panel having a substrate, a plurality of first electrodes, a plurality of second electrodes, a plurality of insulating layers, and a plurality of conducting connectors.

FIG. 2 shows a partially enlarged view of area II of FIG. 1.

FIG. 3 shows a section cross view along a line III-III of FIG. 2.

FIG. 4 shows a process for manufacturing the touch screen panel of FIG. 1.

FIG. 5 shows a flowchart for manufacturing the touch screen panel of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

The term “coupled” is defined as connected, whether directly or indirectly through intervening components, and is not necessarily limited to physical connections. The connection can be such that the objects are permanently connected or releasably connected.

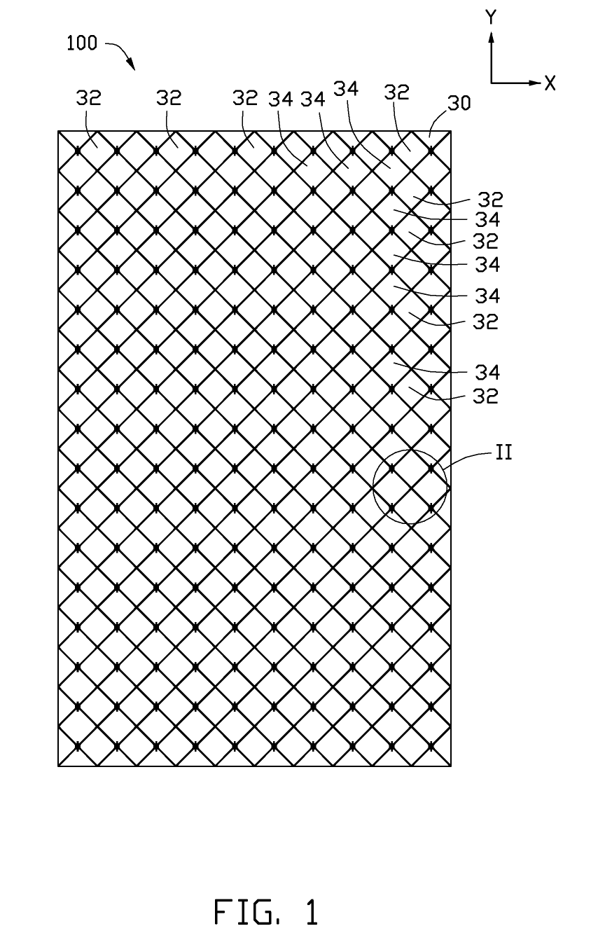

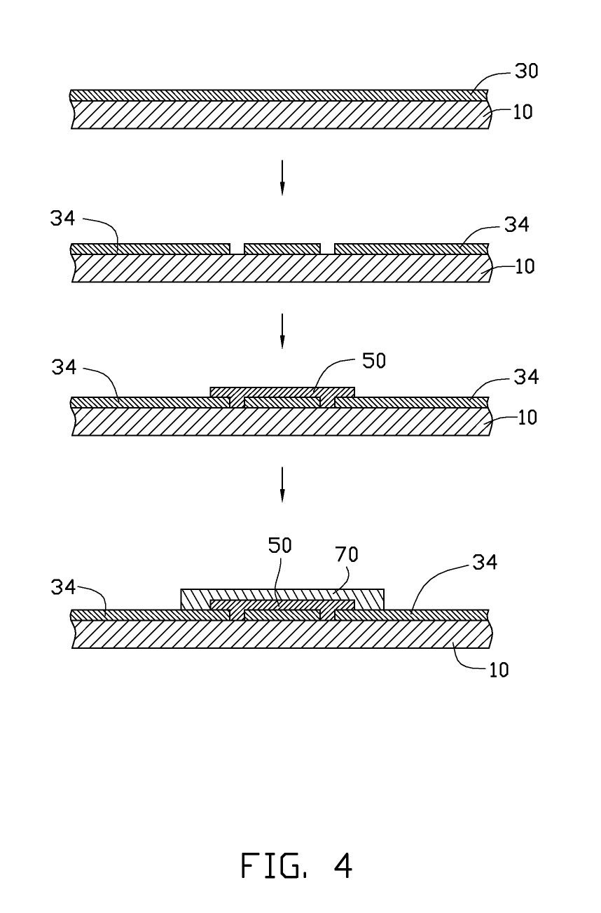

FIGS. 1 and 4 illustrate a touch screen panel 100 of one embodiment including a substrate 10, a plurality of first electrodes 32, and a plurality of second electrodes 34 arranged between the plurality of first electrodes 32. The first electrodes 32 and the second electrodes 34 can be formed in mesh structures on the substrate 10. The first electrodes 32 can be electrically coupled each other in a first direction X. The second electrodes 34 can be arranged between the first electrodes 32 to have separated patterns along a second direction Y that intersects the first direction X, thereby the second electrodes 34 do not overlap the first electrodes 32 and can be insulated from each other. The substrate can be made of a transparent insulation material, such as polyethylene terephthalate (PET), polyimide (PI), or polycarbonate (PC), for example.

The first electrodes 32 and the second electrodes 34 can be formed of a electrode material, such as indium tin oxide (ITO) film, indium-zinc oxide (IZO), zinc oxide (ZnO), carbon nanotubes (CNT), a conductive polymer, or graphene. The substrate 10 can be made of a transparent insulation material, such as PET, PI, or PC for example. The plurality of second electrodes 34 and the plurality of first electrodes 32 can be formed wherein a transparent electrode material layer 30 is etched on the substrate 10.

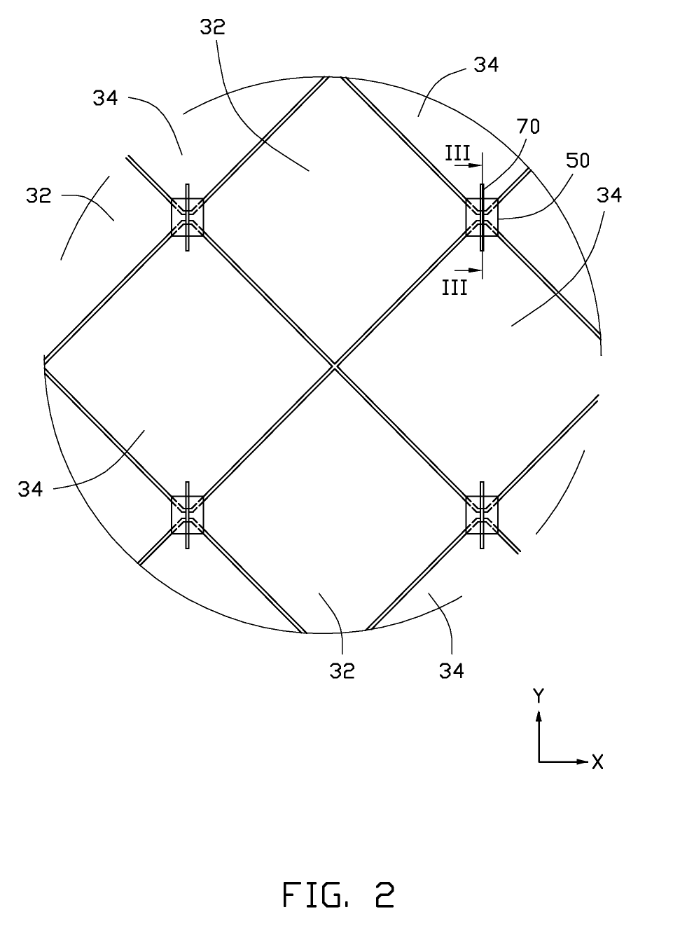

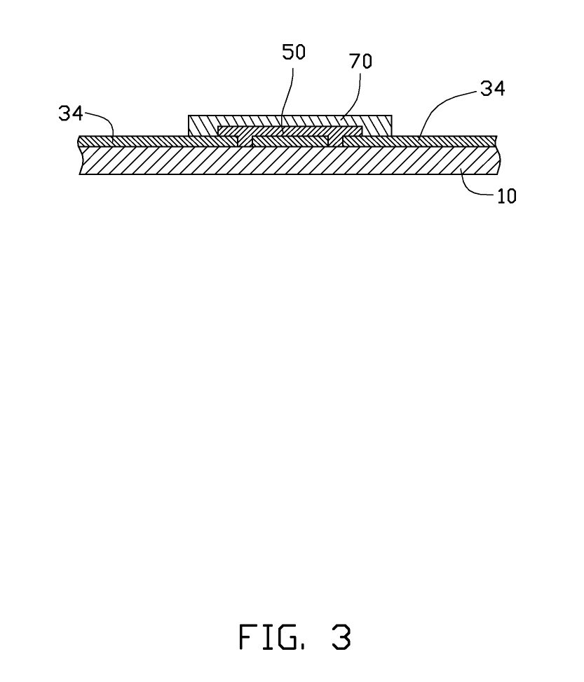

FIGS. 2-3 show a plurality of insulating layers 50 patterned on the plurality of first electrodes 32 and the plurality of second electrodes 34. Each insulating layer 50 can overlap two neighboring second electrodes 34 of the same row along the second direction Y to provide an insulation property. Each insulating layer 50 can overlap a portion of each of two first electrodes 32, which can be positioned adjacent to the two neighboring second electrodes 34. Each insulating layer 50 can be substantially rectangular in shape. A thickness of each insulating layer 50 can be about 1 μm to 3 μm. Each insulating layer 50 can cover a portion of each of the two neighboring second electrodes 34. In other embodiments, the insulating layer 50 can be in other shapes, such as triangular, hexagonal, or circular.

A plurality of conducting connectors 70 can be formed on the plurality of insulating layers 50. Each conducting connector 70 can be formed on one insulating layer 50, and two ends of the conducting connector 70 protrude from the insulating layer 50 to electrically couple with the two neighboring second electrodes 34 in the same row. Thereby, the second electrodes 34 arranged in the same row along the second direction Y can be electrically coupled to each other. The conducting connectors 70 are made of a metal material doped with nonmetal conductive particles to form a rough side surface for improving a scattering property of the conducting connector 70. In the illustrated embodiment, the metal material can be silver or copper, and the nonmetal conductive particles can be carbon nanoparticles or ZnO nanoparticles. In the illustrated embodiment, the conducting connectors 70 and the insulating layers 50 can be formed via an ink jet printing method. The insulating layers 50 are made of thermosetting, UV-type and transparent organic materials, such as PI.

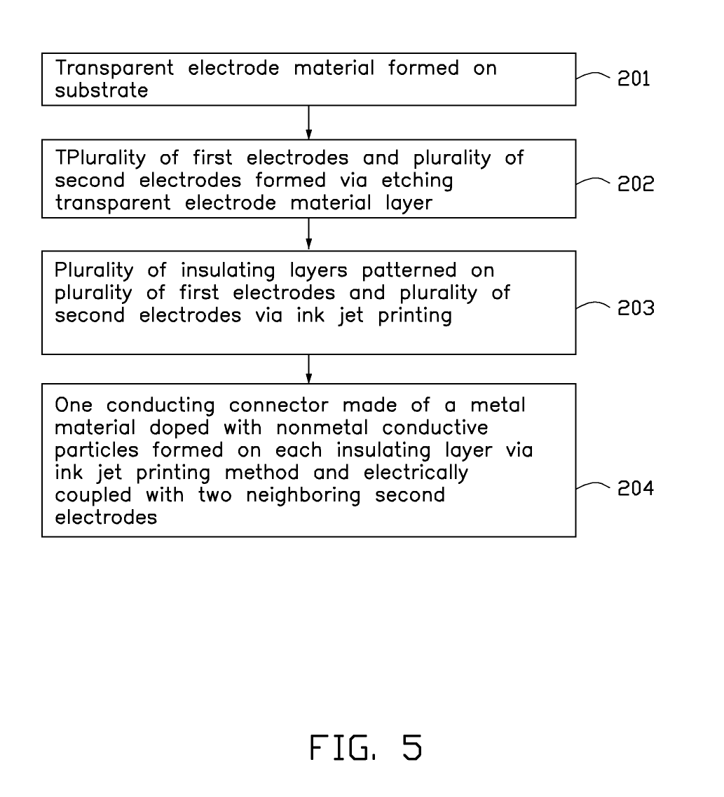

FIGS. 4-5 illustrate the process and method for manufacturing the touch screen panel.

In block 201, the transparent electrode material layer is formed on the substrate. In the illustrated embodiment, the transparent electrode material layer is made of a material such as ITO, IZO, ZnO, CNT, a conductive polymer, or grapheme, which is transparent and has electric conductivity on the substrate. The substrate can be made of transparent insulation material such as PET, PI, or PC, for example. The transparent electrode material layer can be coated on the substrate by a sputtering coating method.

In block 202, the plurality of first electrodes and the plurality of second electrodes are formed via etching the transparent electrode material layer. The first electrodes and the second electrodes can be formed in mesh structures on the substrate. The first electrodes can be electrically coupled to each other along the first direction X. The second electrodes can be dispersed between the first electrodes not overlapping the first electrodes and can be formed to have separated patterns along the second direction Y. Thereby, the second electrodes can be insulated from each other. In present embodiment, the transparent electrode material layer can be etched via a chemical etching method. The first electrodes in the same row along the first direction X can be electrically connected with each other, and the first electrodes in the same row along the second direction Y can be insulated from each other.

In block 203, the plurality of insulating layers are patterned on the plurality of first electrodes and the plurality of second electrodes via ink jet printing. Each insulating layer can be located on at least two neighboring second electrodes along the second direction Y. The insulating layer can be substantially rectangular in shape. In other embodiments, the insulating layer can be in other shapes, such as triangular, a hexagonal, or circular.

In block 204, one conducting connector, made of a metal material doped with nonmetal conductive particles, is formed on each insulating layer via the ink jet printing method, and electrically coupled with the two neighboring second electrodes. In the illustrated embodiment, the metal material can be silver or copper, and the nonmetal conductive particles can be conductive carbon nanoparticles or ZnO nanoparticles.

As described above, the conducting connector made of a metal material doped with nonmetal conductive particles. Thereby, a surface roughness of the conducting connector is improved for improving scattering property of the conducting connector.

In other embodiments, the plurality of insulating layers can be omitted, the conducting connectors can be prepared via a chemical doping method, and each conducting connector can be electrically coupled with the corresponding two neighboring second electrodes via a wire bonding method without contacting the first electrodes. Thus, the step 203 can be omitted when the conducting connector is wire bonded with the corresponding two neighboring second electrodes.

While the present disclosure has been described with reference to particular embodiments, the description is illustrative of the disclosure and is not to be construed as limiting the disclosure. Therefore, those of ordinary skill in the art can make various modifications to the embodiments without departing from the true spirit and scope of the disclosure, as defined by the appended claims.

What is claimed is:

1. A touch screen panel comprising:
a substrate;
a plurality of first electrodes formed on the substrate and extending along a first direction;
a plurality of second electrodes formed on the substrate and extending along a second direction substantially perpendicular to the first direction; and
a plurality of conducting connectors made of a metal material doped with nonmetal conductive particles, each conducting connector electrically coupling with two neighboring second electrodes among the plurality of second electrodes in a same row without contacting the first electrodes.

2. The touch screen panel of claim 1, wherein the nonmetal conductive particles are conductive carbon nanoparticles or zinc oxide nanoparticles.

3. The touch screen panel of claim 1, wherein the metal material is sliver or copper.

4. The touch screen panel of claim 1, further comprising a plurality of insulating layers formed on the plurality of first electrodes and the plurality of second electrodes, each insulating layer formed on two neighboring second electrode among the plurality of second electrodes, each conducting connector is positioned on the corresponding insulating layer, and two ends of the conducting connector protrude from the insulating layer to electrically couple with the two neighboring second electrodes.

5. The touch screen panel of claim 4, wherein the plurality of insulating layers is made of thermosetting, UV-type and transparent organic materials.

6. The touch screen panel of claim 1, wherein the plurality of first electrodes and the plurality of second electrodes are made of one from the group including indium tin oxide film, indium-zinc oxide, zinc oxide, carbon nanotubes, a conductive polymer, and graphene.

7. A method of manufacturing a touch screen panel, comprising:
forming a transparent electrode material layer on a substrate;
etching the transparent electrode material layer and forming a plurality of first electrodes and the plurality of second electrodes arranged between the plurality of first electrodes; and
forming a plurality of conducting connectors made of a metal material doped with nonmetal conductive particles, each conducting connector electrically coupling with two neighboring second electrodes among the plurality of second electrodes in a same row without contacting the first electrodes.

8. The touch screen panel of claim 7, wherein the nonmetal conductive particles are conductive carbon nano particles, or zinc oxide nano particles.

9. The touch screen panel of claim 7, wherein the metal material is sliver or copper.

10. The manufacturing method of claim 7, further comprising forming a plurality of insulating layers on the plurality of first electrodes and the plurality of second electrodes after forming a plurality of first electrodes and a plurality of second electrodes, wherein each conducting connector is formed on one insulating layer, and two ends of the conducting connector protrude from the insulating layer to electrically couple with the two neighboring second electrodes.

11. The touch screen panel of claim 10, wherein the plurality of insulating layers are made of thermosetting, UV-type and transparent organic materials.

12. The manufacturing method of claim 11, wherein the plurality of conducting connectors are formed on the plurality of insulating layers via an ink jet printing method.

13. The manufacturing method of claim 11, wherein the plurality of insulating layers are formed on the plurality of second electrodes via an ink jet printing method.

14. The manufacturing method of claim 10, wherein the transparent electrode material layer is coated on the substrate by a sputtering coating method.
